(19) United States
(12) Patent Application Publication
(10) Pub. No.: US 2017/0244825 A1
(43) Pub. Date: Aug. 24, 2017

(54) PORTABLE ELECTRONIC DEVICE

(71) Applicant: CHI WAI LI, HK (HK)

(72) Inventor: CHI WAI LI, HK (HK)

(21) Appl. No.: 15/433,012

(22) Filed: Feb. 15, 2017

Related U.S. Application Data
(60) Provisional application No. 62/297,810, filed on Feb. 20, 2016.

(51) Int. Cl. H04M 1/725; H04W 4/00

(52) U.S. Cl. CPC H04M 1/72519; H04W 4/008

(57) ABSTRACT

The present subject matter discloses a portable electronic device having multiple functional units for providing distinct functionalities to the portable electronic device. The portable electronic device also has a connection port unit having a plurality of connection ports and coupled to the plurality of functional units. A main controller unit connected to the functional units and the connection port unit. The main controller unit is configured to receive status signals from the functional units based on which it compiles a device status signal. A wireless communication unit is coupled to the main controller unit for facilitating wireless communication with a separate electronic device.

### CROSS-REFERENCE TO RELATED APPLICATIONS

This application claims priority from U.S. provisional patent application Ser. No. U.S. 62/297,810 filed on Feb. 20, 2016, the contents of which are incorporated by reference in their entirety.

### TECHNICAL FIELD

The subject matter of present disclosure relates, in general, to a portable electronic device, and in particular, to a portable electronic device capable of being controlled remotely.

### BACKGROUND

The demand for consumer electronics is on the rise. The increase in demand for modern day consumer electronics may be attributed to the constant reduction in the size of consumer electronic devices. Besides reduction in size, increase in computational and functional capabilities of any electronic device is also contributing in increasing popularity of electronic products. Further, the increased demands has ushered an era of multi-functional electronic devices that are different from cell phones but are capable of performing a multitude of utility based tasks such as battery charging, sound amplification, etc. Such multi-functional electronic devices are compatible with mainstream devices, such as smart-phones and provide enhanced capabilities to the user.

### BRIEF DESCRIPTION OF THE DRAWINGS

FIG. 1 illustrates a block diagram of a portable electronic device, in accordance with an implementation of the present subject matter.

FIG. 2a illustrates an isometric view of the portable electronic device, in accordance with an implementation of the present subject matter.

FIG. 2b illustrates a side view of the portable electronic device, in accordance with an implementation of the present subject matter.

FIG. 3 illustrates an exemplary method in which the portable electronic device communicates with the separate electronic device, in accordance with an implementation of the present subject matter.

### DETAILED DESCRIPTION

Described herein is a portable electronic device having a plurality of hardware functional units for providing multiple functionalities and remote monitoring capabilities to a user of the portable electronic device. The description also discloses a method of controlling the portable electronic device remotely by some separate electronic device, such as smart phone, and the like.

Conventionally, portable electronic devices such as power banks, wireless chargers, despite being small-sized, fail to utilize and make best use of the volume they occupy. For instance, a conventional power bank merely provides a solitary functionality of providing power to other electronic devices. Similarly, wireless speakers fail to provide any additional functionality other than wireless music output. Thus, such devices make inefficient use of space and are not ‘multi-functional’ in true sense.

Other conventional devices, such as one described in US patent application US20140111934, describes multifunctional electronic device having multiple capabilities, such as, power bank functionality, wireless charging, audio output functionality, and the like. However, such conventional electronic devices, despite providing multiple functionalities, fail to provide effective means for monitoring and controlling the conventional electronic devices from a remote device or from a remote location. A user may need to constantly monitor the functioning of the electronic device manually from time to time. Further, the user may be required to be in continuous proximity of the conventional electronic device in case the user intends to manually check and control the functioning of the conventional electronic device. For instance, if a user wants to check the amount of battery left in a power bank of an electronic device, he or she needs to pick up the electronic device and check the battery indication signals of the conventional electronic device, if any. Similarly, if the user needs to charge the electronic device for a specified amount of time, say 1 hour, the user needs to manually turn the charging on and off.

Thus, the conventional electronic devices are inconvenient to control or monitor remotely, and thus, fail to provide a user with ease of access. Additionally, the conventional electronic devices do not allow a user to add additional components for increasing the functionality of the conventional electronic device. This inability of the conventional device to accommodate additional components restricts the functionality of the conventional electronic devices to functional modules that are already present on the electronic device.

The portable electronic device of the present subject matter comprises a plurality of hardware functional units for providing distinct functionalities to the portable electronic device. Examples of functional units include wireless access point unit, battery charging unit, wireless charging unit, wireless speaker unit, wireless headset unit, and the like. The functional units of the portable electronic device are controlled by a main controller unit. The main controller unit, besides controlling the functionality of the portable electronic device is also responsible for compiling a device status signal that includes status information of each of the plurality of functional units. The main controller unit may receive the status information in form of a status signal from each of the functional units. The status information includes information, such as amount of battery power left in the battery charging unit, and similar information that signify a present, past, or future status of any functional unit of the portable electronic device. More details about status information are provided later in the description.

The main controller unit is capable of sending the device status signal to some separate electronic device, such as a cell phone paired with the portable electronic device. The separate electronic device may be paired to the portable electronic device of the present subject matter by means of a wireless communication unit. The device status signal is capable of being read by the separate electronic device, thus enabling the separate electronic device to access the status of each of the functional units. The main controller unit is also capable of receiving a control signal, from the separate electronic device. The control signals comprise instructions for controlling each of the plurality of functional units. Based on the received control signal, the main controller unit may control, or alter, the status of the functional units.

The portable electronic device also includes a connection port unit comprising a plurality of ports coupled to the plurality of functional units and the main controller unit. In addition, the portable electronic device further comprises the wireless communication unit coupled at least to the main controller unit for facilitating wireless communication with the separate electronic device.

The portable electronic device of the present subject matter provides advantages, such as provisioning convenient remote access of the status information to the user, who can monitor and control the portable electronic device remotely from the separate electronic device. Further, the device acts as a multi-functional electronic device by providing functionalities, such as wired battery charging, wireless battery charging, audio play, wireless headset functionality, wireless access point, and the like. The portable electronic device enables an efficient utilization of a small volume, thus rendering the portable electronic device to be highly portable.

Additionally, the portable electronic device of the present subject matter allows an addition of a variety of hardware modules, such as weather monitoring module, D/C-A/C or A/C-D/C conversion module, additional battery module, and the like. This enables the portable electronic device to have additional functionalities according to the needs of user. The portable electronic device can also be used by travellers or students who need to carry multiple devices for a variety of requirements. In an implementation, the functionality of adding additional hardware modules may be realised by utilizing a plurality of ports of the portable electronic device.

The portable electronic device also provides environmental friendly advantages. For instance, the charging time of the battery charging unit of the portable electronic device can be controlled remotely according to user convenience. This allows the portable electronic device to charge any compatible device, such as a mobile phone, for an optimum period of time and thus avoid overcharging. Also, since the portable electronic device combines the functionality of multiple electronic devices into one, it effectively reduces carbon footprint of a user who would have otherwise used, and later thrown away, multiple gadgets to achieve the same functionality.

These and other advantages of the present subject matter will be disclosed in upcoming sections of the present disclosure, along with description of embodiment figures. In the following description, numerous details are set forth. It will be apparent, however, to one skilled in the art, that the present disclosure may be practiced without these specific details. In some instances, well-known structures and devices are shown in block diagram form, rather than in detail, in order to avoid obscuring the present disclosure.

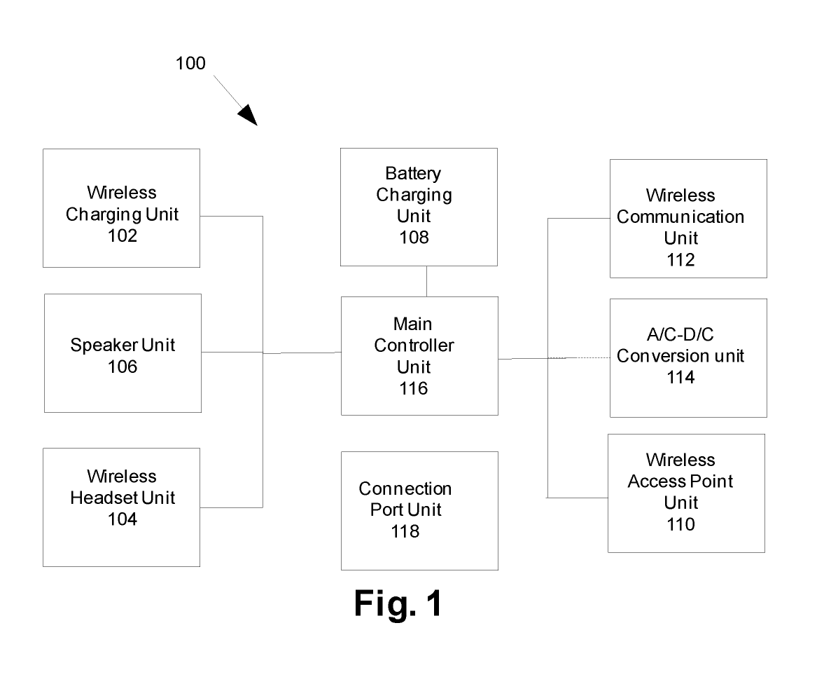

FIG. 1 illustrates a block diagram of the disclosed portable electronic device 100, in accordance with an implementation of the present subject matter.

As illustrated in FIG. 1, the portable electronic device 100 comprises a plurality of functional units. The functional units include wireless charging unit 102, wireless headset unit 104, speaker unit 106, battery charging unit 108, wireless access point unit 110, and A/C-D/C conversion unit 114. It may be noted that though FIG. 1 illustrates certain specific functional units, other embodiments/implementations of the portable electronic device 100 may have additional or lesser functional units.

The portable electronic device 100 also comprises a connection port unit 118 coupled to the plurality of functional units. The connection port unit 118 comprises a plurality of connection ports such as USB port, RJ-45 port, SIM card slot, memory card slot, and the like. The connection ports of the connection port unit 118 are electrically connected to the functional units of the portable electronic device 100 and provide a variety of utility to the portable electronic device 100. For example, the RJ-45 port allows the portable electronic device 100 to be connected to the internet through a LAN cable. The wireless access point unit 110 may further act as a Wi-Fi router and provide internet facility to Wi-Fi enabled devices proximate to the portable electronic device 100.

The portable electronic device 100 further includes a main controller unit 116. The main controller unit 116 is electrically connected to each functional unit of the portable electronic device 100 and to other units such as the connection port unit 118 and a wireless communication unit 112. The main controller unit 116 comprises at least a processor capable of accessing and controlling the functionality of each functional unit. For instance, the main controller unit 116 can access a status of each functional unit in form of a status signal received from the functional units, and initiate, stop, or modify, a functionality of the particular functional unit as needed.

For this, the main controller unit 116 is configured to receive at least one status signal from each functional unit, wherein the at least one status signal comprises status information from the functional units. Based on the at least one status signal, the main controller unit 116 compiles a device status signal, wherein the device status signal at least comprises status information for each of the plurality of functional units.

The portable electronic device 100 comprises the wireless connection unit 112 for facilitating wireless communication of the portable electronic device 100 with other devices. In an implementation, the wireless communication unit 112 is a bluetooth connection module that allows the portable electronic device 100 to communicate with some separate electronic device. It may be noted that the wireless communication unit 112 may implement wireless connectivity using a connection module utilizing at least one of Wi-Max, Wi-Fi, Zigbee, and similar connection formats.

The description hereinafter describes functionality and connectivity related details of the each of the functional units of the portable electronic device 100.

### Battery Charging Unit

The battery charging unit 108 is a functional unit that allows an external electronic device to be connected to and be charged by the portable electronic device 100. In an implementation, the battery charging unit 108 comprises a lithium ion polymer charging circuit having a cell LED fuel gauge, 2.1 A at 5V and 1 A at 5V output function. The battery charging unit may also be connected to standard LEDs for indicating remaining battery life of the battery charging unit 108.

In yet another implementation of the present subject matter, the battery charging unit sends status information, in the form of a status signal, to the main controller unit 116. The status information include information, such as amount of battery power left, battery drainage status, time remaining to full charge a connected device, auto charging turn-off timer, and the like. Further, the main controller unit 116 is capable of controlling the functioning of the battery charging unit 108.

The battery charging unit 108 is connected to and provides power to other functional unit of the portable electronic device 100.

### A/C-D/C Conversion Unit

The portable electronic device 100 comprises an A/C-D/C conversion unit 114 as a functional unit for converting A/C power received by the portable electronic device to D/C power that is usable by the functional units and present day electronic devices. In order to receive A/C power, the A/C-D/C conversion unit 114 comprises an adaptor plug which can be coupled to any A/C wall socket. The adaptor plug may be a universal wall plug that can be coupled to most of the wall sockets present around the world. In order to convert the A/C power received from the adaptor plug to D/C power, the A/C-D/C conversion unit 114 comprises a switch mode power supply (SMPS) circuit. In an implementation, the A/C-D/C conversion unit 114 is a detachable module that is coupled to the portable electronic device 100 by a USB plug.

In an example, the A/C-D/C conversion unit 114 is utilized to charge the battery charging unit 108. The A/C-D/C conversion unit 114 can also be utilized to directly supply power to each of the plurality of functional units of the portable electronic device 100 in case the battery charging unit 108 runs out of power.

The A/C-D/C conversion unit 114 sends, in the form of a status signal, status information such as device receiving A/C power (Yes/No), to the main controller unit 116. Further, the main controller unit 116 is capable of controlling the functioning of the A/C-D/C conversion unit 114.

Wireless Charging Unit

The wireless charging unit 102 is a functional unit that allows any other electronic device to be charged wirelessly. The wireless charging unit 102 comprises wireless charging circuitry, i.e. at least one primary inductive coil utilizing inductive charging, which can charge a wireless charging enabled device to be charged wirelessly. In an implementation, the portable electronic device 100 may comprise more than one wireless charging circuitry to enable charging of a plurality of wireless charging enabled device simultaneously. In order to wirelessly charge any device the wireless charging unit 102 draws power either the battery charging unit 108 or directly from A/C-D/C conversion unit 114, in case the portable electronic device is receiving direct A/C power. In other implementations, the wireless charging unit 102 may utilize other wireless charging techniques, such as resonance charging, radio charging, and the like.

In an implementation the wireless charging unit 102 sends, in the form of a status signal, status information, such as charging on (Yes/No), remaining charge time, and the like to the main controller unit 116. Further, the main controller unit 116 is capable of controlling the functioning of the wireless charging unit 102.

### Speaker Unit

The speaker unit 106 is a functional unit that allows the portable electronic device 100 to play audio. The speaker unit 106 comprises an audio amplifier circuit coupled to micro speakers for amplifying sound. In an implementation, the speaker unit receives an audio signal wirelessly from the separate electronic device, thus enabling the portable electronic device 100 to function like a wireless speaker. In an example the speaker unit 106 receives audio signal from the separate electronic device via the wireless headset unit 104. The speaker unit may also have a dedicated bluetooth module for receiving the audio signals wirelessly from a paired bluetooth enabled electronic device. In an implementation, the speaker unit 106 may selectively receive power from the battery charging unit 108 and the A/C-D/C conversion unit 114, as per availability. Additionally, the portable electronic device 100 may comprise volume control buttons for allowing manual control of the volume of the speaker unit 106.

In an implementation, the speaker unit 106 sends, in form of a status signal, status information, such as volume level, and the like, to the main controller unit 116. Further, the main controller unit 116 is capable of controlling the functioning of the speaker unit 106.

### Wireless Headset Unit

The portable electronic device 100 comprises a wireless headset unit 104 as a functional unit for enabling a user to wirelessly listen to an audio signal. In an implementation, the wireless headset unit 104 is detachable from the portable electronic device 100. The audio signal may be received from the separate electronic device paired with the wireless headset unit 104 in the portable electronic device 100. For instance, the audio may be received during a voice call taking place via the separate electronic device paired with the detachablewireless headset unit 104 in the portable electronic device.

In an implementation, the portable electronic device 100 includes a stereo sound enabled wireless headset unit 104. The wireless headset unit 104 is electrically coupled to and charged through the battery charging unit 108. The wireless headset unit 104 may also be charged through power provided through A/C-D/C conversion unit 114, when the portable electronic device 100 is receiving A/C power from a wall socket.

In an implementation, the wireless headset unit 104 sends, in the form of a status signal, status information, such as volume level, charge remaining, bluetooth pairing status, and the like, to the main controller unit 116 by utilizing a micro USB interconnection between the wireless headset unit 104 and the portable electronic device 100. Further, the main controller unit 116 is capable of controlling the functioning of the wireless headset unit 104.

### Wireless Access Point Unit

The wireless access point unit 110 of the portable electronic device 100 is a functional unit that is a wireless access point (WAP) device capable of acting as a router. In an implementation, the wireless access point unit 110 is coupled to a RJ-45 port of the connection port unit 118. The RJ-45 port allows the wireless access point unit 110 to connect to a network, such as a LAN network, and provide wireless access to separate electronic devices, such as mobile phones and tablets, present in the proximity of the portable electronic device 100. The wireless access point unit 110 may also utilize other means, such as a 3/4G SIM card module attached to the SIM card slot for providing wireless access to the separate electronic devices.

In an implementation, the wireless access point unit 110 derives power from the battery charging unit 108. The wireless access point unit 110 may also get power through power provided through A/C-D/C conversion unit 114, when the portable electronic device 100 is receiving A/C power from a wall socket.

In an implementation, the wireless access point unit 110 sends, in the form of a status signal, status information, such as connection status, connection speed, bandwidth, network details, and the like, to the main controller unit 116. Further, the main controller unit 116 is capable of controlling the functioning of the wireless access point unit 110.

In the present implementation, the connection port unit 118 comprises multiple ports, such as one RJ-45 port, one USB port, one micro USB port, and a SIM card slot.

Each connection port of the connection port unit 118 is coupled to at least one functional unit of the portable electronic device 100. For instance, the RJ-45 port is at least coupled to the wireless access point unit 110 and the main controller unit 116. Similarly, the USB port may be connected to the main controller unit 116, the battery charging unit 108, the speaker unit 106, and the like.

The main controller unit 116 is configured to receive the status information from each of the plurality of functional units, as described previously. The main controller unit 116, based on the received status information from the plurality of functional units, compiles the device status signal. The main controller unit 116 is further configured to send the device status signal to the separate electronic device that has been paired with the portable electronic device 100 by utilizing the wireless communication unit 112. In an implementation, the main controller unit 116 encrypts, or encodes, the device status signal before sending the same to the separate electronic device.

It may be noticed that the device status signal is capable of providing the separate electronic device with the status information of the functional units of the portable electronic device. In order to see the status information, the user may install a compatible mobile application which facilitates the user to visualize and control the functionality of the functional units of the portable electronic device 100. The mobile application may also provide the user with an option of controlling the functionality of the functional units of the portable electronic device 100. In case a user opts for controlling the functionality, the mobile application may send a control signal to the main controller unit 116 of the portable electronic device 100 by the wireless communication unit 112. The main controller unit 116 receives the control signal and accordingly control the functioning of the functional unit whose functionality is instructed to be controlled by the control signal.

In an example, the user may choose an option to reduce the volume of an audio playing through the speaker unit 106. The main controller unit 116 receives a control signal by the wireless communication unit 112 from the separate electronic device and accordingly reduces or increases the volume of the speaker unit. In an implementation the control signal may be in encrypted form. In such scenarios, the main controller unit 116 first decrypts the control signal and then alters the functionality of the portable electronic device 100. Thus, the user does not require to physically touch the device for accessing and controlling the various functionalities.

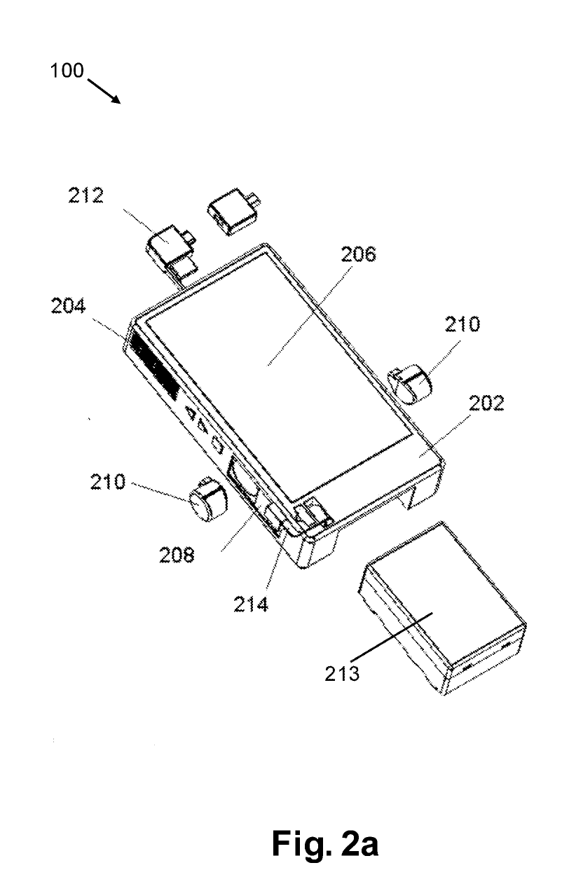

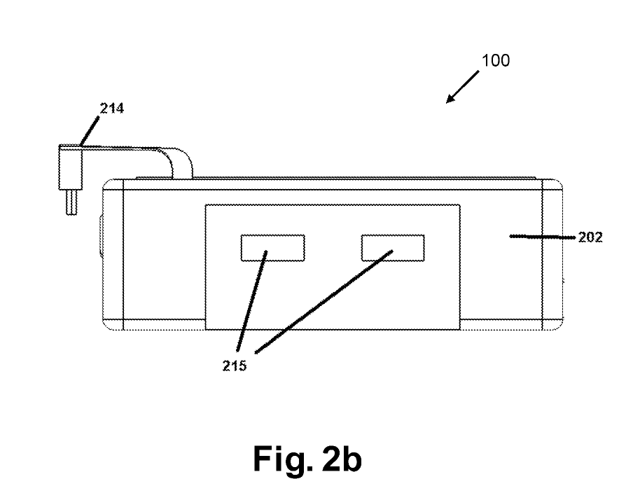

FIG. 2a illustrates an isometric view of the portable electronic device 100, in accordance with an implementation of the present subject matter.

The implementation depicted in FIG. 2a discloses the portable electronic device 100 having an approximately cuboidal shape. The cuboidal shape is achieved by utilizing a casing 202 that encases the various functional units, the main controller unit 116 and other elements of the portable electronic device 100. On one side of the portable electronic device 100, speaker grill 204 is depicted. The speaker grill 204 provides an open area through which an output sound from the speaker unit 106 to emerge out. Thus, the speaker grill 204 acts as an opening for the speaker unit 106 which is present inside the portable electronic device 100, and not visible in FIG. 2a.

The casing of the portable electronic device 100 includes a wireless charging surface 206. The wireless charging surface 206 provides a user with a clear demarcation for the area on which a wireless charging enabled device needs to be placed to initiate wireless charging. Thus, the wireless charging surface 206 is located close to the inductive coil of the wireless charging unit 102 of the portable electronic device 100. In an example, the wireless charging surface 206 is a micro suction pad. As mentioned earlier, the portable electronic device 100 may comprise of more than one inductive coil for charging multiple devices simultaneously.

The portable electronic device also includes the connection port unit 118 comprising multiple connection ports. The connection ports, such as the USB plug port 215, allow the portable electronic device 100 to provide additional utilities, or functionalities via a detachable module. For instance, the USB plug port 215, shown in FIG. 2b, allows the portable electronic device 100 to be connected to a weather station module. The weather station module may provide the portable electronic device 100 with weather related information for a particular location. Similarly, the portable electronic device may comprise other ports, thereby allowing the portable electronic device 100 to couple with a variety of external units for enhancing the utility provided to the user. Such functionalities may also enable the portable electronic device 100 to collect important data. The portable electronic device 100 may also be connected online, using SIM card or LAN network, to become a part of Internet of Things (IoT) and upload the data online.

The portable electronic device 100 includes at least one wireless ear piece 210 that is a part of the wireless headset unit 104. The wireless ear piece 210 depicted in FIG. 2a is a part of a pair of wireless headsets. The wireless ear piece 210 is a part of the wireless headset unit 104. Each wireless ear piece 210 includes a bluetooth unit to receive audio/voice signals from a paired separate electronic device. This functionality allows the user to effortlessly receive calls using the wireless headset unit 104.

The wireless ear piece 210 may be stored within a compartment provided within the portable electronic device 100. The wireless ear piece 210 may be placed within the compartment and prevented to fall out by means of sliding doors 208, as depicted in FIG. 2a. Each ear piece 210 may have a micro USB port installed within it. Similarly, insides of the compartment may be housed with at least one micro USB male plug for mating with the micro USB port of the ear piece 210, thereby facilitating the charging of the ear piece 210.

The portable electronic device 100 also has two sets of cables, namely upper retractable cable 212 and lower retractable cable 214. The upper retractable cable 212 is a retractable cable which is capable of being retractably rolled within the compartment of the portable electronic device 100 as shown in FIG. 2a. The upper retractable cable 212 comprises a micro USB and USB male components as depicted FIG. 2a. The micro USB male component is be utilized to charge a device using power from the battery charging unit 108, thereby allowing the portable electronic device to act as a power bank. The USB male components is used to charge the battery charging unit 108 through some other electronic device such as a laptop or to conventional wall mounted chargers having a USB port.

The retractable rolling of the cable may be realised by rolling the cable around a pulley coupled to a spring based mechanism. The spring based mechanism allows the cable to be automatically wound back around the pulley when the user no longer wants to use the cable.

In an implementation, the portable electronic device also comprises the lower retractable cable 214 having a single micro USB male connector to charge external electronic device. The provision of two retractable cables makes the portable electronic device 100 compact. Further, there is no requirement for a user to carry additional cables to charge devices, resulting in high degree of user convenience.

A/C-D/C conversion unit 114 is illustrated in FIG. 2a as detachable power unit 213. Thus, the detachable power unit is detachably coupled to the portable electronic device 100. For facilitating detachability, the detachable power unit 213 comprises a USB, or micro USB socket on the surface. The USB socket of the detachable power unit 213 can be coupled to any USB plug port of the portable electronic device 100 to facilitate detachability of the detachable power unit 213 from the portable electronic device 100. The detachable power unit 213 also comprises an adaptor plug for connecting to a wall socket.

FIG. 2b illustrates a side view of the portable electronic device, in accordance with an implementation of the present subject matter. The USB plug ports 215, as described in the previous paragraph is depicted in FIG. 2b. The USB plug ports 215 allow the portable electronic device 100 to couple to externaldetachable modules, such as the weather station module. FIG. 2b further depicts the lower retractable cable 214 having a single micro USB male connector to charge external electronic device. In an implementation, the USB plug port 118 is a part of the connection port unit 118.

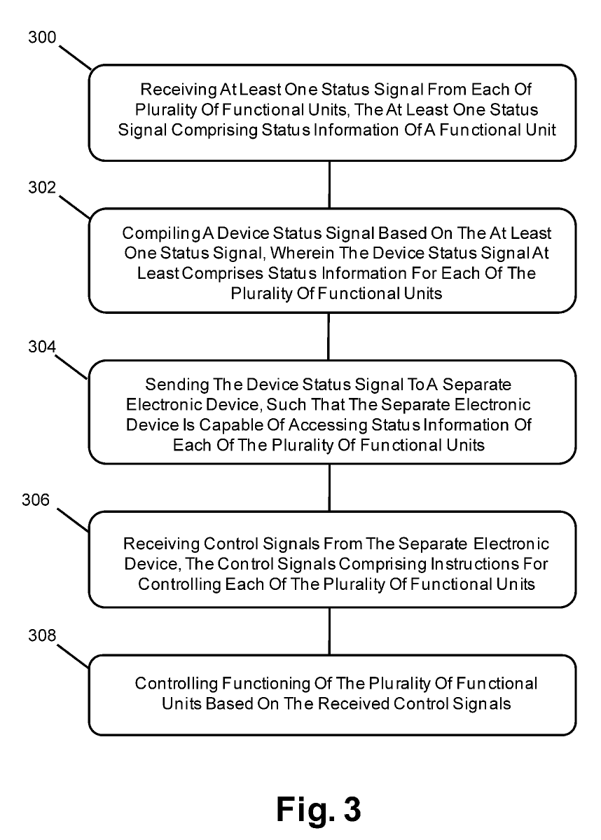

FIG. 3 illustrates an exemplary method in which the portable electronic device 100 communicates with the separate electronic device, in accordance with an implementation of the present subject matter. The communication of the portable electronic device with the separate electronic device allows the separate electronic device to control the portable electronic device 100. The order in which the following method has been described shall not be used to limit the scope of invention and the method may be utilized in any alternate manner to achieve the functioning of the claimed invention.

At block 300, the main controller unit 116 of the portable electronic device 100 receives the status information from each of the plurality of functional units in form of status signals. As explained earlier, the status information may include information, such as battery drainage status, speaker volume, bluetooth pairing status, and the like.

At block 302, the main controller unit 116 utilizes the status information from each of the plurality of functional units and compiles a device status signal. The device status signal at least includes status information for each of the plurality of functional units.

At block 304, the main controller unit 116 sends the device status signal to separate electronic device, such as a cell phone. In an implementation, the device status signal may be main controller unit 116 encrypts the device status signal before sending to the separate electronic device. The device status signal is capable of being decoded by the separate electronic device using a mobile application. Further, the device status signal provides the separate electronic device with an access to the status information of each of the plurality of functional units.

At block 306, the main controller unit 116 receives control signals from the separate electronic device. The control signals are intended to control the functionality of the functional units of the portable electronic device 100. Thus, the control signals comprise instructions for controlling each of the plurality of functional units. In an implementation, the main controller unit 116 receives the control signals in an encrypted form.

At block 308, the main controller unit 116 controls functionality of the functional units of the portable electronic device 100 based on the information, or instruction provided in the control signals. In the implementation where the main controller unit 116 receives the signal in an encrypted form, the main controller unit 116 first decrypts the control signals for extracting information.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

I/we claim:

1. A portable electronic device comprising:
a plurality of functional units for providing distinct functionalities to the portable electronic device;
a connection port unit comprising a plurality of connection ports and coupled to the plurality of functional units;
a main controller unit electrically connected to each of the plurality of functional units, and the connection port unit, wherein the main controller unit is configured to:
receive at least one status signal from each of the plurality of functional units, wherein the at least one status signal comprises status information of a functional unit; and
compile a device status signal based on the at least one status signal, wherein the device status signal at least comprises status information for each of the plurality of functional units; and
a wireless communication unit coupled at least to the main controller unit for facilitating wireless communication with a separate electronic device.

2. The portable electronic device as claimed in claim 1, further comprising a casing for encasing the plurality of functional units and the main controller of the electronic device.

3. The portable electronic device as claimed in claim 1, the plurality of functional units include at least one of a wireless access point unit, a speaker unit, a wireless headset unit, a battery charging unit, a wireless charging unit, a A/C-D/C conversion unit, and a wireless access point unit.

4. The portable electronic device as claimed in claim 3, wherein the A/C-D/C conversion unit and the wireless headset unit are detachably coupled to the portable electronic device.

5. The portable electronic device as claimed in claim 1, wherein the wireless communication unit comprises a connection module utilizing at least one of Wi-Max, Wi-Fi, and Zigbee connection format.

6. The portable electronic device as claimed in claim 1, wherein the main controller is further configured to receive at least one control signal from the separate electronic device, wherein the control signals comprise instructions for controlling each of the plurality of functional units.

7. The portable electronic device as claimed in claim 5, wherein the device status signal and the at least one control signals are in encrypted form.

8. A method of controlling the portable electronic device, of claim 1, by the separate electronic device, the method comprising:
receiving, by a main controller unit of the portable electronic device, at least one status signal from each of a plurality of functional units, the at least one status signal comprises status information a functional unit;
compiling, by the main controller unit, a device status signal based on the at least one status signal, wherein the device status signal at least comprises status information for each of the plurality of functional units;
sending, by the main controller unit, the device status signal to a separate electronic device, such that the separate electronic device is capable of accessing status information of each of the plurality of functional units;
receiving, by the main controller unit, control signals from the separate electronic device, the control signals comprising instructions for controlling each of the plurality of functional units; and
controlling, by the main controller unit, functioning of the plurality of functional units based on the received control signals.

9. The method as claimed in claim 8, wherein the main controller unit encrypts the device status signal before sending the device status signal to the separate electronic device.

10. The method as claimed in claim 8, wherein the main controller unit decrypts the control signal received from the electronic device.
